(19) United States
(12) Patent Application Publication
(10) Pub. No.: US 2014/0209724 A1
(43) Pub. Date: Jul. 31, 2014

(54) NUT BUTTER MAKER

(71) Applicant: NOSTALGIA PRODUCTS GROUP, LLC, Green Bay, WI (US)

(72) Inventors: Gregg Bond, Beverly Hills, CA (US); Edward E. Boughton, III, Ventura, CA (US)

(73) Assignee: NOSTALGIA PRODUCTS GROUP, LLC, Green Bay, WI (US)

(21) Appl. No.: 13/756,261

(22) Filed: Jan. 31, 2013

(51) Int. Cl. A47J 43/07; B65D 47/18

(52) U.S. Cl. CPC A47J 43/07; B65D 47/18
USPC 241/38; 222/183

(57) ABSTRACT

A nut butter maker of the type used in the home in the nature of a small electrical appliance with a motor which rotates a grinding unit for grinding chopped nuts such as almonds, hazelnuts and walnuts so as to have a butter like consistency. An integrated oil dispenser is insertable into a sleeve with a stirrer at its end so that oil can be dispensed onto the nuts as they are being ground. The stirrer is rotated to dislodge nuts so that they are directed onto the grinding unit.

### BACKGROUND OF THE INVENTION

The invention concerns nut butter makers for use in a home as opposed to a commercial environment.

### SUMMARY OF THE INVENTION

The invention is directed to a nut butter maker of the type used in the home and is in the nature of a small electrical appliance with a motor which rotates a grinding unit for grinding chopped nuts such as almonds, hazelnuts and walnuts so as to have a butter like consistency. Although nut butter makers of this type are known in the art, the invention includes an integrated oil dispenser which is insertable into a sleeve with a stirrer at its end so that oil can be dispensed onto the nuts as they are being ground, and the stirrer can be rotated to dislodge nuts that become jammed near the base of a bin used to hold the nuts as they are being ground so that the nuts are directed onto the grinding unit.

### BRIEF DESCRIPTION OF THE DRAWINGS

FIG. 1 is a perspective view showing the invented nut butter maker and a portion of the integrated oil dispenser and sleeve.

FIG. 2 is detailed partial cut-away, side view in elevation showing the oil dispenser prior to being inserted completely into the sleeve and a bin of the nut butter maker.

FIG. 3 is detailed partial cut-away, side view in elevation showing the oil dispenser fully inserted into the sleeve and the bin of the nut butter maker.

### DETAILED DESCRIPTION OF THE INVENTION

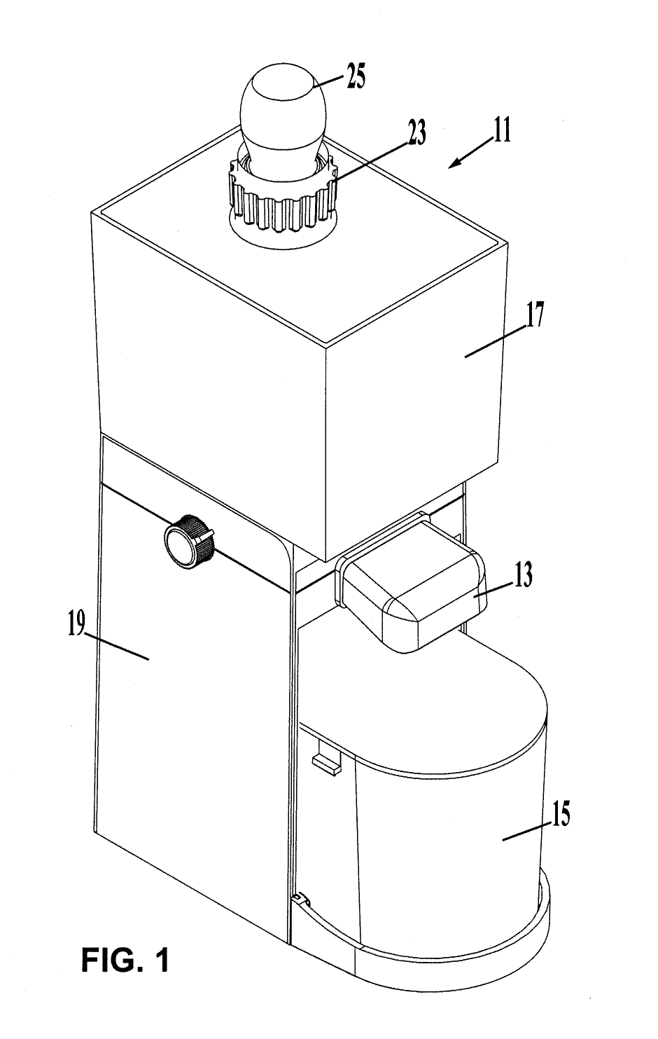

Referring first to FIG. 1, the invented nut butter maker 11 includes a chute 13, container 15, nut bin 17, base 19, bin cover 21.

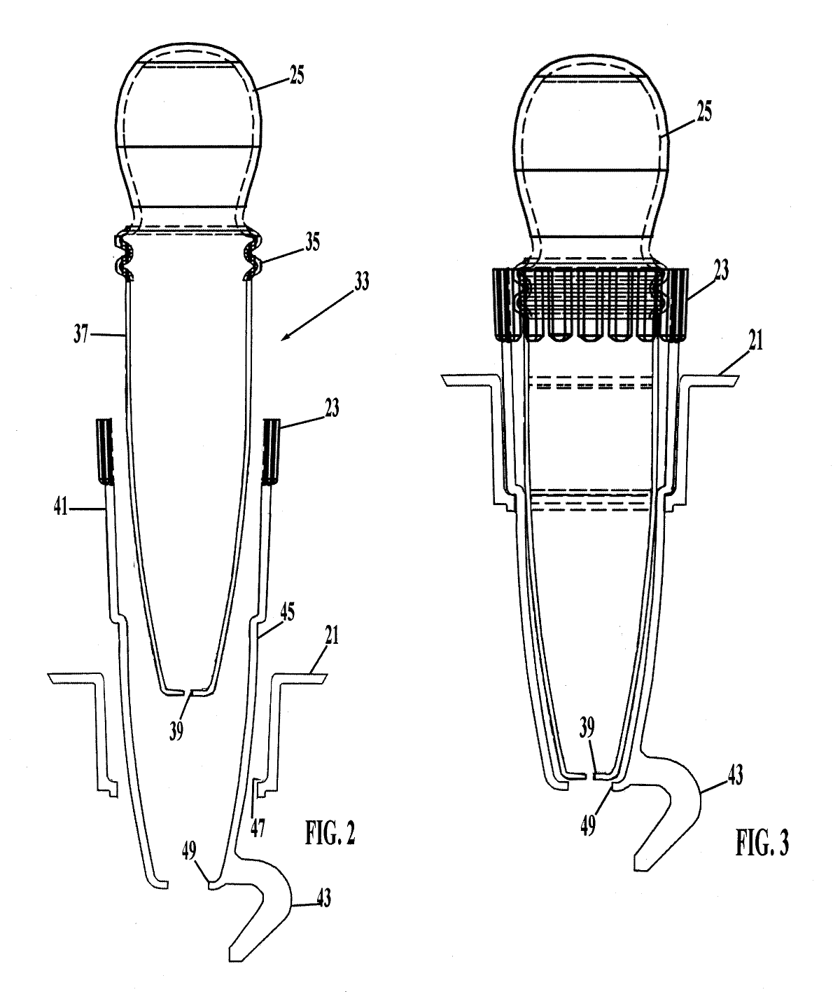

Chopped nuts such as almonds, hazelnuts, walnuts, macadamia nuts, sunflower seeds, pecans, cashews, pistachios and the like are placed into nut bin 17. A motor in base 19 rotates a grinding unit (not shown) which grinds the chopped nuts to have a butter-like consistency. The nut butter flows from chute 13 into container 15. Further details regarding the components and operation of the nut butter maker as shown in FIG. 1 are omitted since such components and operation are well known in the art. However, FIG. 1 includes some of the elements which form the present invention, namely finger grip 23 and bulb 25 which are described below with reference to FIG. 2.

Referring now to FIG. 2, the present invention differs from the prior art mainly in the addition of oil dispenser 33 and stir/sleeve 41. Oil dispenser 33 includes rubber bulb 25 and ribs 35 which are used to attach rubber bulb 25 to oil dropper 37. Oil dropper 37 includes a hole 39 through which oil in oil dropper 37 drips when pressure is applied by squeezing rubber bulb 25.

Oil dispenser 33 is insertable into stir/sleeve 41. Stir/sleeve 41 includes finger grips 23 and hook 43. Stir/sleeve 41 fits into an opening in bin cover 21. Stir/sleeve 41 includes an indented portion 45 so that stir/sleeve 41 can fit into an opening in bin cover 21, but cannot be inserted further than a predetermined amount. Bin cover 21 includes ledge 47 which engages with portion 45 to limit the extent to which the stirrer can be inserted into bin 17. The amount to which stir/sleeve 41 is insertable into bin 17 is an amount sufficient so that when stir/sleeve is rotated, hook 43 is able to stir nuts that may become jammed inside bin 17, but not so far as to hit the grinding mechanism inside base 19. Stir/sleeve 41 also includes a hole 49 at its base so that oil dripping from hole 39 passes through stir/sleeve 41 onto nuts being ground

Although not shown in FIG. 1, typically, the lower portion of the sides of bin 17 slope inward so as to guide nuts which are inside the bin into an opening at the base of bin cover 21 which is just above the grinding mechanism in base 19. Finger grip 23 is used to allow stir/sleeve 41 to be easily rotated so that as hook 43 rotates around the base of bin 17, nuts which are near the opening of the grinding mechanism can be loosened. Typically, finger grip 23 completely surrounds a top portion of stir/sleeve 43 as shown in FIG. 3 and includes ridges or the like to enable the stir/sleeve to be easily rotated by the fingers of the user.

In operation, oil dispenser 33 is partially filled with oil such as vegetable oil, canola oil, sunflower oil, grape seed oil, or the like. After the unit is turned on, and the nut butter maker begins to grind the nuts, rubber bulb 25 is gently squeezed so as to dispense oil through opening 39 which allows nut butter of a desired consistency to be produced and flow from chute 13 to container 15.

We claim:

1. An oil dropper for a nut butter maker having a bin for holding nuts, a grinder for grinding the nuts into a nut butter, a chute for discharging produced nut butter into a container, said bin including an opening on a top surface thereof for receiving said oil dropper, said oil dropper comprising:
a) a sleeve which is insertable into said opening having a top portion which forms a finger grip, a middle portion which engages a ledge formed below said opening to limit an extent to which said sleeve is insertable into said opening, and a bottom portion which includes a hole and a hook which extends below said hole;
b) an oil dispenser which is insertable into said sleeve, said oil dispenser including a top portion for engaging a removable bulb, a middle portion forming a taper which extends to a bottom portion of said oil dispenser, a hole formed at an end of said bottom portion of said oil dispenser and disposed so as to enable oil inside said oil dispenser to be discharged directly into said hole in said bottom portion of said sleeve by operation of said bulb.

2. The oil dropper defined by claim 1 wherein said oil dispenser includes ribs at a top portion thereof, and said bulb includes corresponding ribs at a bottom portion thereof, said dispenser ribs and bulb ribs configured for attaching said bulb to said dispenser.

3. A nut butter maker including a bin for holding nuts, a grinder for grinding the nuts into a nut butter, a chute for discharging produced nut butter into a container, said bin including an opening on a top surface thereof, said nut butter maker further comprising:
a) a removable oil dispenser;
b) a sleeve for receiving said oil dispenser which is insertable into said opening, said sleeve having a top portion, a middle portion which engages a ledge formed below said opening to limit an extent to which said sleeve is insertable into said opening, and a bottom portion which includes a hole and a hook which extends below said hole;
said oil dispenser including a top portion for engaging a removable bulb, a middle portion forming a taper which extends to a bottom portion of said oil dispenser, a hole formed at an end of said bottom portion of said oil dispenser and disposed so as to enable oil inside said oil dispenser to be discharged directly into said hole in said bottom portion of said sleeve by operation of said bulb.

4. The nut butter maker defined by claim 3 wherein said oil dispenser includes ribs at a top portion thereof, and said bulb includes corresponding ribs at a bottom portion thereof, said dispenser ribs and bulb ribs configured for attaching said bulb to said dispenser.

5. The nut butter maker defined by claim 3 wherein said top portion of said sleeve includes a finger grip around a top portion of said sleeve.

6. The nut butter maker defined by claim 5 wherein said finger grip includes ridges.

7. The oil dispenser defined by claim 1 wherein said top portion of said sleeve includes a finger grip around a top portion of said sleeve.

8. The nut butter maker defined by claim 7 wherein said finger grip includes ridges.
